(19) United States
(12) Patent Application Publication
(10) Pub. No.: US 2017/0338042 A1
(43) Pub. Date: Nov. 23, 2017

(54) THIN-FILM CAPACITOR AND METHOD OF MANUFACTURING THE SAME

(71) Applicant: SAMSUNG ELECTRO-MECHANICS CO., LTD., Suwon-si (KR)

(72) Inventors: Hyun Ho SHIN, Suwon-si (KR); Kyo Yeol LEE, Suwon-si (KR); Dong Joon OH, Suwon-si (KR); Woong Do JUNG, Suwon-si (KR); Ho Phil JUNG, Suwon-si (KR); Hai Joon LEE, Suwon-si (KR); Seung Mo LIM, Suwon-si (KR); Jong Bong LIM, Suwon-si (KR)

(21) Appl. No.: 15/369,493

(22) Filed: Dec. 5, 2016

(30) Foreign Application Priority Data
May 17, 2016 (KR) 10-2016-0059937

(51) Int. Cl. H01G 4/33; H01G 4/012; H01G 4/30

(52) U.S. Cl. CPC H01G 4/33; H01G 4/012; H01G 4/306

(57) ABSTRACT

A thin-film capacitor includes: a body in which a plurality of dielectric layers and first and second internal electrodes are alternately disposed on a substrate; and first and second external electrode disposed on an external surface of the body. A plurality of vias are disposed in the body, a first via connects first internal electrodes to each other, and penetrates from the external surface of the body to the lowermost first internal electrode, a second via connects second internal electrodes to each other, and penetrates from the external surface of the body to the lowermost second internal electrode, and the plurality of vias have a multistage shape, and at least one internal electrode has an etched portion of 0.3 to 0.7 layer in relation to one layer of the internal electrode.

### CROSS-REFERENCE TO RELATED APPLICATION(S)

This application claims the benefit of priority to Korean Patent Application No. 10-2016-0059937 filed on May 17, 2016 in the Korean Intellectual Property Office, the entire disclosure of which is incorporated herein by reference.

### TECHNICAL FIELD

The present disclosure relates to a thin-film capacitor and a method of manufacturing the same.

### BACKGROUND

Portable information technology (IT) products such as smartphones, wearable devices, and the like, have recently been thinned. Accordingly, there is a necessity for thinness in passive elements to allow an overall thickness of a package to be decreased.

To this end, demand for a thin-film capacitor having a thickness lower than that of a multilayer ceramic capacitor has also increased.

When a capacitor product is manufactured using a thin-film method, the method of forming a via connecting external electrodes and internal electrodes and performing an interlayer connection of the internal electrodes is important. The method for forming the via and the final structure of the via may affect the performance of the thin-film capacitor.

In a method of manufacturing a thin-film capacitor according to the related art, when a via is formed after repeatedly stacking a dielectric layer and an electrode layer, one via is required for one electrode layer. Therefore, there is provided a method of forming a via as the number of electrode layers.

Next, as a method of patterning the electrode layers when the electrode layers are stacked, in a case in which even-numbered electrode layers and odd-numbered electrode layers having different forms are stacked, and one side of the laminate is etched, only the even-numbered or odd-numbered electrode layers are exposed to connect the electrodes.

However, since the above-mentioned methods have problems in that operations are complex and manufacturing costs may be increased, a technology capable of easily manufacturing a more miniaturized thin-film capacitor is required.

Furthermore, when a plurality of dielectric layers are stacked using thin-film technology, it is very important, in terms of improving the reliability of a product, to stably connect the electrode layers disposed on an upper portion and a lower portion of each of the dielectric layers.

### SUMMARY

An aspect of the present disclosure provides a thin-film capacitor having excellent reliability and which may be miniaturized, and a method of manufacturing the same.

According to an aspect of the present disclosure, a thin-film capacitor includes: a body in which a plurality of dielectric layers and first and second internal electrodes are alternately disposed on a substrate; and first and second external electrodes disposed on an external surface of the body, wherein a plurality of vias are disposed in the body, a first via of the plurality of vias connects first internal electrodes to each other, and penetrates from the external surface of the body to the lowermost first internal electrode, a second via of the plurality of vias connects second internal electrodes to each other, and penetrates from the external surface of the body to the lowermost second internal electrode, and the plurality of vias have a multistage shape, and at least one internal electrode has an etched portion of 0.3 to 0.7 layer in relation to one layer of the internal electrode.

According to another aspect of the present disclosure a method of manufacturing a thin-film capacitor may include: preparing a laminate by stacking dielectric layers and first and second internal electrodes on a substrate so that the dielectric layers and the first and second internal electrodes are alternately disposed; forming a via by applying a photoresist on a top surface of the laminate, patterning the photoresist, and then performing an etching to a predetermined internal electrode; and forming a plurality of vias by removing the patterned photoresist, stacking an insulating layer on the top surface of the laminate, applying the photoresist, patterning the photoresist, and then etching the insulating layer, and then filling the via with a conductive metal in a via filling operation, wherein each of the vias is formed to have a smaller width than an upper via, adjacent thereto, wherein each of the vias is formed to have a smaller width than an upper via, adjacent thereto, wherein the plurality of vias have a multistage shape, and at least one internal electrode has an etched portion of 0.3 to 0.7 layer in relation to one layer of the internal electrode.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a plan view of a thin-film capacitor according to an exemplary embodiment in the present disclosure;

FIG. 2 is a cross-sectional view taken along line I-I′ of FIG. 1;

FIGS. 3A through 3J are views of an operation of forming a via within a thin-film capacitor according to another exemplary embodiment in the present disclosure; and

FIGS. 4A through 4D are views of an operation of forming an insulating layer in a via within a thin-film capacitor according to another exemplary embodiment in the present disclosure.

### DETAILED DESCRIPTION

Hereinafter, exemplary embodiments of the present disclosure will now be described in detail with reference to the accompanying drawings.

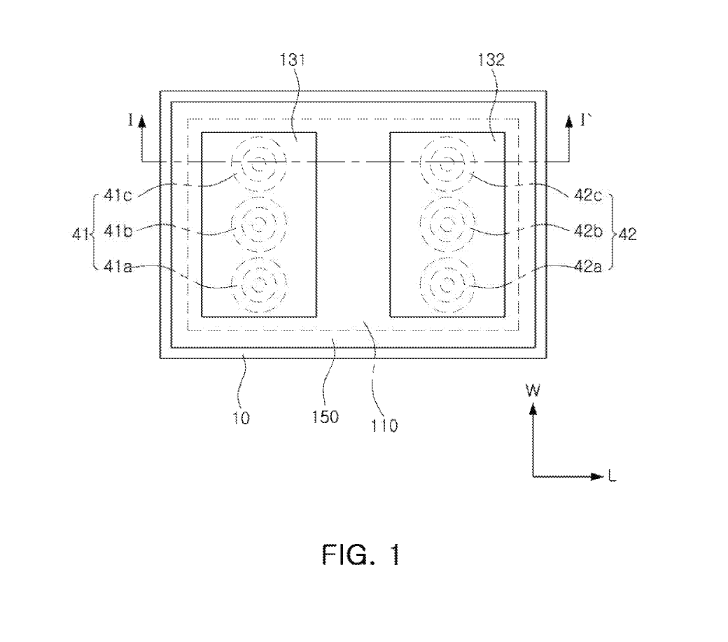

FIG. 1 is a plan view of a thin-film capacitor according to an exemplary embodiment in the present disclosure.

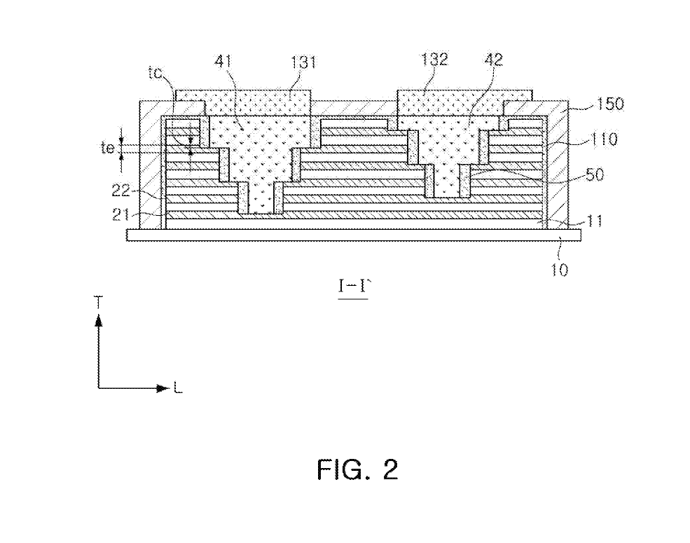

FIG. 2 is a cross-sectional view taken along line I-I′ of FIG. 1.

Referring to FIGS. 1 and 2, a thin-film capacitor according to an exemplary embodiment may include a body 110 including a plurality of dielectric layers 11 and first and second internal electrodes 21 and 22, the first and second internal electrodes 21 and 22 being alternately disposed with at least one among the plurality of dielectric layers being interposed therebetween, on a substrate 10, and first and second external electrodes 131 and 132 disposed on an external surface of the body 110.

The first internal electrodes 21 may include a lowermost first internal electrode 21, and the second internal electrodes 22 may include a lowermost second internal electrode, the lowermost first and second internal electrodes being the first and second internal electrodes most adjacent to the substrate 10, respectively, and a plurality of vias 41 and 42 may be disposed in the body 110.

The plurality of vias 41 and 42 may include a plurality of first vias 41 and a plurality of second vias 42. Although each of the plurality of first and second vias 41 and 42 are illustrated as three vias 41a, 41b, 41c, and 42a, 42b, 42c, respectively, in FIG. 1, the number of vias is not limited thereto, and a large number of vias may also be formed.

According to an exemplary embodiment, a ‘length direction’ of the thin-film capacitor refers to an ‘L’ direction of FIG. 1, a ‘width direction’ thereof refers to a ‘W’ direction of FIG. 1, and a ‘thickness direction’ thereof refers to a ‘T’ direction of FIG. 2. The ‘thickness direction’ is the same as a direction in which the dielectric layers and the internal electrodes are stacked, that is, a ‘stacking direction’.

A shape of the body 110 is not particularly limited, but may be generally a hexahedral shape. Further, a dimension of the body 110 is not particularly limited, but may have a size of, for example, 0.6 mm×0.3 mm, and the thin-film capacitor according to the present disclosure may be a high stacked and high-capacity thin-film capacitor of 1.0 μF or more.

According to an exemplary embodiment, a material of the dielectric layer 11 may be barium titanate (BaTiO₃) powder, but is not limited thereto. For example, a perovskite-based material may be widely applied, to which other impurities may be added.

The first and second internal electrodes 21 and 122 may be formed of one or more materials of copper (Cu), platinum (Pt), nickel (Ni), silver (Ag), gold (Au), iridium (Ir), and silver-palladium (Ag—Pd), and may be formed by an operation of forming a thin-film.

The first and second external electrodes 131 and 132 may be formed on a top surface of the body 110, and may be electrically connected to the first and second internal electrodes 21 and 22 through the plurality of vias 41 and 42, exposed through one surface of the body 110.

Such first and second external electrodes 131 and 132 may be formed on the top surface of the body 110 by the operation of forming a thin-film such as a sputtering operation or an e-beam deposition operation.

The body 110 may be formed by stacking the dielectric layers 11 and the first and second internal electrodes 21 and 22 on the substrate 10 so that the dielectric layers 11 and the first and second internal electrodes 21 and 22 are alternately disposed.

More specifically, the body 110 may be formed by stacking the plurality of dielectric layers 11 in a thickness direction of the body 110, and alternately stacking the first and second internal electrodes 21 and 22 facing the dielectric layers 11, as illustrated in FIG. 2, wherein the dielectric layers 11 and the first and second internal electrodes 21 and 22 are collectively stacked within a vacuum.

According to an exemplary embodiment, interlayer etching is performed on different areas in order to selectively connect the internal electrodes of the thin-film capacitor, collectively stacked within the vacuum, such that the via may be formed to have a multistage shape, that is, a stepped shape.

In addition, by forming an insulating layer on an internal electrode to be insulated among the internal electrodes exposed through the via, etched in the stepped shape, an electrical connection may be prevented.

Next, only the electrode to be connected is exposed, a seed layer is then formed by an electroless plating or sputtering method, and a conductive metal is then disposed by plating, whereby an electrode connection layer may be formed.

By the above description, an interlayer electrical connection of the internal electrodes may be implemented by a single via.

According to an exemplary embodiment, since the thin-film capacitor is manufactured by collectively stacking the dielectric layers 11 and the first and second internal electrodes 21 and 22 within the vacuum, damage which may occur by the thin-film capacitor being exposed to an external environment may be significantly reduced.

According to an exemplary embodiment, a protection layer 150 for protecting a stacked multilayer structure may be disposed on the external surface of the body 110 in which the dielectric layers 11 and the first and second internal electrodes 21 and 22 are collectively stacked within the vacuum.

The plurality of vias 41 and 42 may have the multistage shape, and at least one internal electrode may have an etched portion of 0.3 to 0.7 layer in relation to one layer of the internal electrode.

A thin-film capacitor having a plurality of dielectric layers according to the related art uses a method in which the number of layers penetrated by one etching is limited to a natural number to thereby accurately penetrate through the layers to a surface of an electrode part.

However, dry etching may have a difficulty in that a distribution of a temporal or spatial etching rate may be wide, and it may be difficult to accurately adjust other etching amounts due to characteristics of equipment.

For example, in a case in which an etching amount is finely reduced due to an irregular temporal distribution of equipment, the dry etching on a surface of the electrode layer needs to be stopped, but since the etching amount may be insufficient, a case in which the dielectric, which is not etched, remains on the surface of the electrode layer may occur.

This case may cause a reduction of dielectric capacity and an increase of equivalent series resistance (ESR) by an electrical open.

In particular, as a plurality of layers are stacked, a stable electrical connection with each of the electrode layers becomes more important.

For example, when a plurality of through-holes are formed by a single etching process, as in the related art, if the etching amount is insufficient, the etching amounts of all of the through-holes become insufficient. As a result, there may arise a phenomenon in which the connection with each of the electrode layers becomes unstable.

According to an exemplary embodiment, since at least one internal electrode may be adjusted to have the etched portion of 0.3 to 0.7 layer in relation to one layer of the internal electrode within the plurality of vias 41 and 42, the stable electrical connection may be obtained even in a case in which the plurality of electrodes are connected through one via.

Specifically, a dry etching amount may be adjusted so that a portion at which the via and the electrode layer are in contact with each other is formed at an intermediate portion of the electrode layer in relation to the thickness of the electrode layer in order to form the via connecting the plurality of electrode layers, whereby a stable electrical connection may be obtained even in the case in which the plurality of electrodes are connected through one via.

Referring to FIG. 2, when it is assumed that a thickness of one layer of the internal electrode is to and a thickness of the etched portion etched in relation to one layer of the internal electrode is tc, tc/te may have a value of 0.3 to 0.7.

By adjusting tc/te to have the value of 0.3 to 0.7, the stable electrical connection may be obtained even in the case in which the plurality of electrodes are connected through one via.

In a case in which tc/te is less than 0.3, since the thickness of the etched portion may be excessively small, the dielectric layer may remain on the internal electrode according to the distribution of the etching amount. As a result, the reduction of dielectric capacity and the increase of equivalent series resistance (ESR) by the electrical open may be caused.

In a case in which tc/te exceeds 0.7, since the thickness of the etched portion may be high, leading to the risk of over-etching, when the internal electrode is penetrated according to the distribution of the etching amount, and in this case, one or more layers of the internal electrodes may not be connected, thereby reducing capacitance.

At least one internal electrode may have the etched portion of 0.3 to 0.7 layer in relation to one layer of the internal electrode, and the etched portion may be formed by performing the penetration by adding a penetration amount of the etching as many as 0.3 to 0.7 layer in relation to one layer of the internal electrode when performing the dry etching in order to form the plurality of vias 41 and 42.

According to an exemplary embodiment, since at least one internal electrode is adjusted to have the etched portion of 0.3 to 0.7 layer in relation to one layer of the internal electrode, the stable electrical connection may be obtained even in a case of an unexpected change of the etching amount according to an increase of the number of stacked internal electrodes.

The first via 41 of the plurality of vias 41 and 42 may connect the first internal electrode 21 and the first external electrode 131, and may penetrate through from one surface of the body 110 to the lowermost first internal electrode 21.

In addition, the second via 42 of the plurality of vias 41 and 42 may connect the second internal electrode 22 and the second external electrode 132, and may penetrate from one surface of the body 110 to the lowermost second internal electrode 22.

According to an exemplary embodiment, the plurality of vias 41 and 42 may have the multistage shape, the stepped shape, and a width of each stage of the plurality of vias may be increased in a direction from the substrate 10 to an upper portion of the body 110.

By manufacturing the first and second vias 41 and 42 so that the width of each stage thereof is increased in a direction from the substrate 10 to the upper portion of the body 110 as described above, the first via 41 may be connected to all of the first internal electrodes 21 disposed in the body 110, and the second via 42 may be connected to all of the second internal electrodes 22 disposed in the body 110, as described below.

In addition, since the width of each stage of the first and second vias 41 and 42 is increased in a direction from the substrate 10 to the upper portion of the body 110, the first internal electrode 21 exposed in the first via 41 and the second internal electrode 22 exposed in the second via 42 may have an insulating layer 50 disposed on etched cutting surfaces thereof, and top surfaces thereof may be exposed.

Since the first via 41 repeats the etching multiple times to the layer to which the first internal electrode 21 is exposed and has the multistage shape, the stepped shape, and the width of each stage is increased in a direction from the substrate 10 to the upper portion of the body 110, the insulating layer 50 may be disposed on the etched cutting surface of the dielectric layer 11 and the first and second internal electrodes 21 and 22, and only the top surface of the first internal electrode 21 may be exposed, after an insulating operation.

Thereby, all of the first internal electrodes 21 may be electrically connected to each other in the first via 41, and may be electrically connected to the first external electrode 131 through the first via 41.

Since the second via 42 repeats the etching multiple times to the layer to which the second internal electrode 22 is exposed and has the multistage shape, the stepped shape, and the width of each stage is increased in a direction from the substrate 10 to the upper portion of the body 110, the insulating layer 50 may be disposed on the etched cutting surface of the dielectric layer 11 and the first and second internal electrodes 21 and 22, and only the top surface of the second internal electrode 22 may be exposed, after an insulating operation.

Thereby, all of the second internal electrodes 22 may be electrically connected to each other in the second via 42, and may be electrically connected to the second external electrode 132 through the second via 42.

In addition, the insulating layer 50 may be disposed on the second internal electrode 22 exposed in the first via 41 and the first internal electrode 21 exposed in the second via 42.

Specifically, the insulating layer 50 may be disposed on the etched cutting surfaces of the second internal electrode 22 exposed in the first via 41 and the first internal electrode 21 exposed in the second via 42.

According to an exemplary embodiment, the first via 41 may be connected to all of the first internal electrodes 21 disposed in the body 110, and the second via 42 may be connected to all of the second internal electrodes 22 disposed in the body 110.

According to an exemplary embodiment, since the first via 41 is connected to all of the first internal electrodes 21 and the second via 42 is connected to all of the second internal electrodes 22, there is no problem in forming capacitance even in a case in which one or a plurality of internal electrodes are not connected to the via due to an operational variance.

That is, in the structure in which one internal electrode is connected to one via as in the related art, if the connection fails, capacitance is not formed. As a result, a problem in which capacitance of the capacitor is degraded may occur.

However, according to an exemplary embodiment, since the first via 41 is connected to all of the first internal electrodes 21 and the second via 42 is connected to all of the second internal electrodes 22, there is no problem in forming capacitance of the capacitor even in a case in which some of the internal electrodes are not connected to the via. As a result, reliability may be excellent.

The first via 41 may be provided in plural, and a plurality of first vias 41 may have the same depth as each other. The second via 42 may also be plural and a plurality of second vias 42 may also have the same depth as each other.

That is, the first via 41 may penetrate from one surface of the body 110 to the first internal electrode 21 of the lowermost layer, the second via 42 may penetrate from one surface of the body 110 to the second internal electrode 22 of the lowermost layer, the plurality of first vias may have the same depth as each other, and the plurality of second vias may also have the same depth as each other.

Hereinafter, an example of manufacturing a thin-film capacitor according to an exemplary embodiment will be described, but the present disclosure is not limited to the exemplary embodiment.

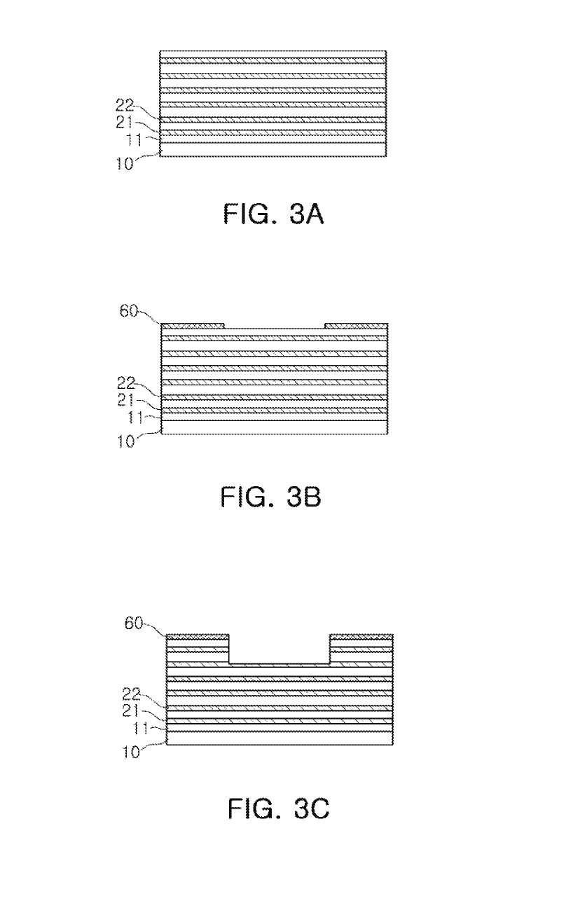

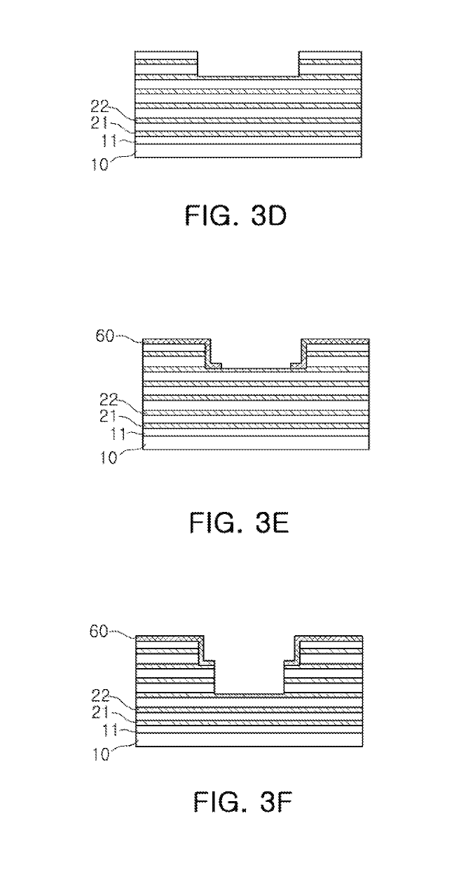

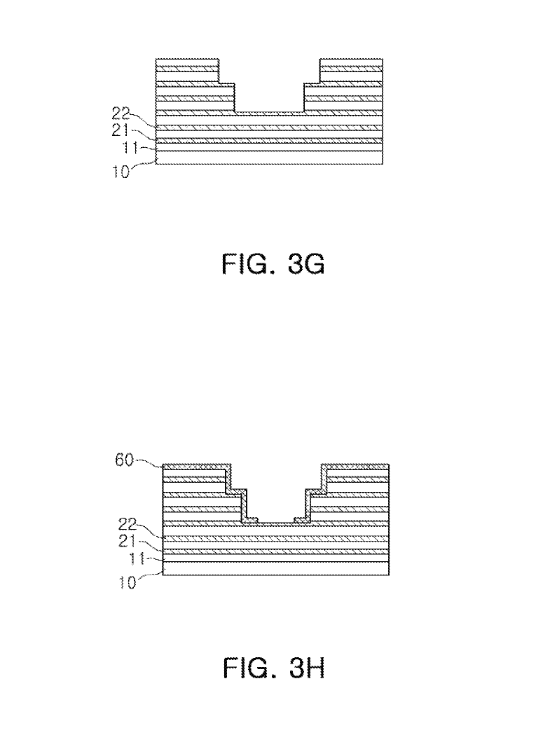

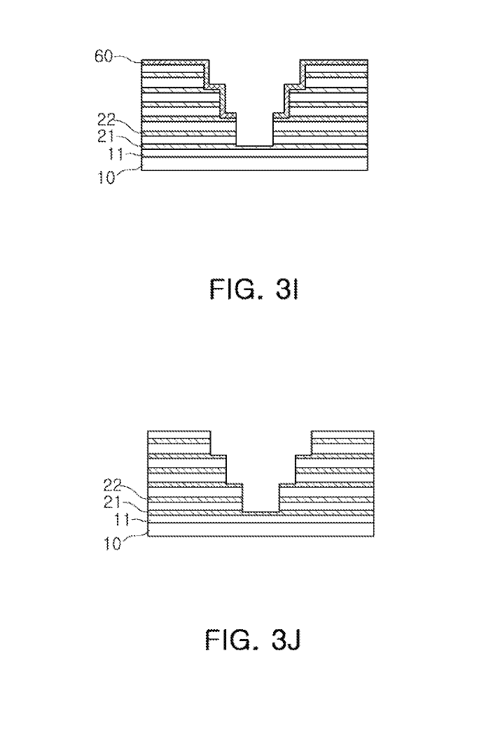

FIGS. 3A through 3J are views of an operation of forming a via within a thin-film capacitor according to another exemplary embodiment in the present disclosure.

Hereinafter, an operation of forming a via within a thin-film capacitor will be described with reference to FIGS. 3A through 3J.

Referring to FIG. 3A, a laminate may be prepared by stacking the dielectric layers 11 and the first and second internal electrodes 21 and 22 on the substrate 10 so that the dielectric layers 11 and the first and second internal electrodes 21 and 22 are alternately disposed.

The substrate 10 is not particularly limited, and may be, for example, a prepreg.

The dielectric layer 11 may be formed by depositing a perovskite-based dielectric material such as barium titanate (BaTiO₃) on the substrate 10, the first internal electrode 21 may be formed by depositing a conductive metal on the dielectric layer 11 using an operation of forming a thin-film such as a sputtering operation, an e-beam deposition operation, or the like, and the dielectric layer 11 and the second internal electrode 22 may again be formed on the first internal electrode 21.

Thereby, the plurality of first and second internal electrodes 21 and 22 may be formed so that the first and second internal electrodes 21 and 22 are alternately stacked through end surfaces, opposing each other, of the dielectric layer 11.

The stacking of the dielectric layers 11 and the first and second internal electrodes 21 and 22 is performed by deposition, but is not limited thereto. For example, the stacking thereof may be formed by an operation such as a chemical solution deposition (CSD).

The stacking of the dielectric layers 11 and the first and second internal electrodes 21 and 22 may be performed by collectively stacking the dielectric layers 11 and the first and second internal electrodes 21 and 22 without a separate patterning operation in the vacuum state.

Referring to FIG. 3B, in order to expose interlayer electrodes disposed in the laminate, a photoresist 60 may be applied to a top surface of the laminate, and the photoresist 60 may be patterned by an exposure and development operation.

Referring to FIG. 3C, an etching may be performed to a predetermined internal electrode to form a via.

The via illustrated in FIG. 3C is a first via, and the via may be formed by performing the etching to the first internal electrode, adjacent to the top surface of the laminate so that the first internal electrode, most adjacent to the top surface of the laminate, is exposed.

According to an exemplary embodiment, a penetration may be performed by adding a penetration amount of etching 0.3 to 0.7 layer in relation to one layer of the internal electrode.

In this case, since additional etching is performed on an exposed part of the first internal electrode as compared to other regions, the exposed part of the first internal electrode may have a thinner thickness.

In particular, since a thickness of an added etched portion of the internal electrode has a thickness of 0.3 to 0.7 layer in relation to one layer of the internal electrode, the thickness of the internal electrode of the exposed region may be reduced by as much as the thickness of the added etched portion as compared to other regions.

Referring to FIG. 3D, the patterned photoresist 60 may be removed.

Referring to FIG. 3E, the photoresist 60 may be applied from the top surface of the laminate to a bottom surface of the via, that is, a top surface of the exposed first internal electrode, and the photoresist 60 may be patterned by the exposure and development operation.

The patterned photoresist 60 may be patterned in an area narrower than the photoresist 60 patterned in FIG. 3B.

Referring to FIG. 3F, next, an operation of performing an etching to a predetermined internal electrode to forma via may be performed.

The via illustrated in FIG. 3F is the first via, and the via may be formed to be connected to the first internal electrode by performing the etching to the first internal electrode so that the first internal electrode following the first internal electrode, most adjacent to the top surface of the laminate in a direction of the substrate from the top surface of the laminate, is exposed.

In the etching operation, the dielectric layer and the second internal electrode disposed between the first internal electrode, most adjacent to the top surface of the laminate, and the first internal electrode following the first internal electrode, most adjacent to the top surface of the laminate, may be simultaneously exposed.

That is, the layers penetrated per the etching operation conducted once may include two or more electrodes and dielectric layers.

The via may be formed to have a smaller width than the via formed by performing the etching so that the first internal electrode, most adjacent to the top surface of the laminate, is exposed.

According to an exemplary embodiment, a plurality of vias may be formed by repeatedly performing the operations, and each of the vias may be formed to have a smaller width than an upper via adjacent thereto.

Specifically, referring to FIG. 3G, the patterned photoresist 60 may be removed.

Referring to FIG. 3H, the photoresist 60 may be applied from the top surface of the laminate to a bottom surface of the via formed in FIG. 3F, that is, a top surface of the exposed first internal electrode, and the photoresist 60 may be patterned by the exposure and development operation.

The patterned photoresist 60 may be patterned in an area narrower than the photoresist 60 patterned in FIG. 3E.

Referring to FIG. 3I, next, an operation of performing an etching to a predetermined internal electrode to forma via may be performed.

As illustrated in FIG. 3I, the via may be formed by performing etching so that the first internal electrode disposed below the first internal electrode exposed in FIG. 3F is exposed.

In the etching operation, the dielectric layer and the second internal electrode disposed between the first internal electrode exposed in FIG. 3F and the first internal electrode disposed below the first internal electrode exposed in FIG. 3F may be simultaneously exposed.

The via may be formed to have a smaller width than the via formed in FIG. 3F.

Referring to FIG. 3J, the patterned photoresist 60 may be removed.

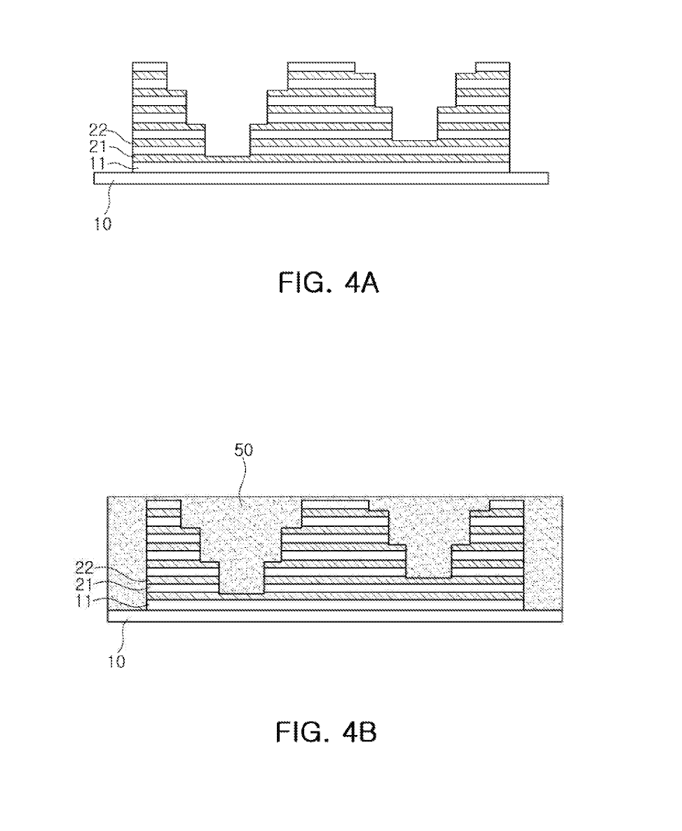

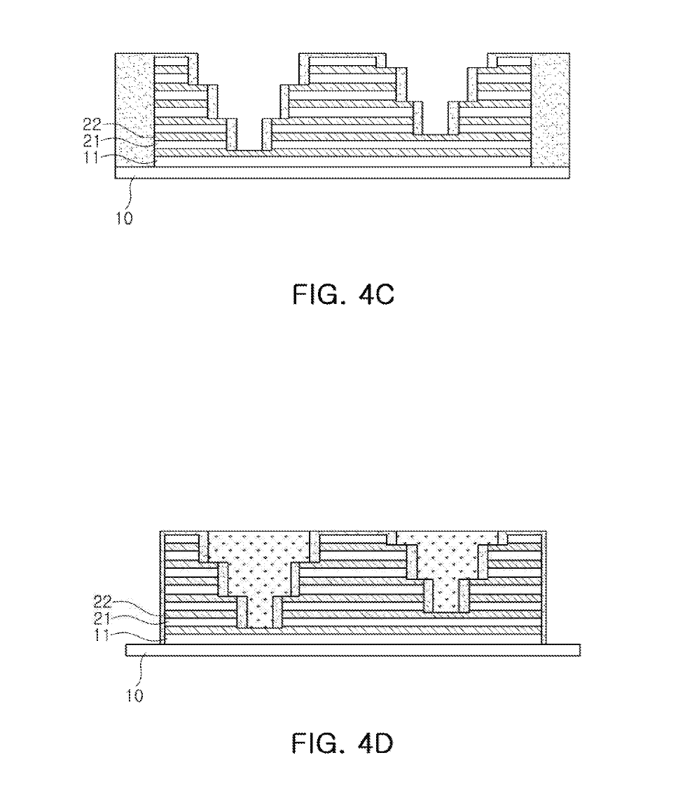

FIGS. 4A through 4D are views of an operation of forming an insulating layer in a via within a thin-film capacitor according to another exemplary embodiment in the present disclosure.

FIGS. 4A through 4D illustrate operations of patterning an insulating layer to selectively connect the exposed electrodes.

That is, the first via needs to be connected to the first internal electrode and the exposed second internal electrode needs to be insulated at the same time. The second via needs to be connected to the second internal electrode, and the exposed first internal electrode needs to be insulated at the same time.

Therefore, the first via needs to prevent an electrical connection by using the second internal electrode as the dielectric or the insulating layer, and the second via needs to prevent the electrical connection by using the first internal electrode as the dielectric or the insulating layer.

FIG. 4A illustrates a cross section of the laminate in which the first via and the second via are formed by the operations of FIGS. 3A through 3J.

The first via may penetrate from one surface of the laminate to the lowermost first internal electrode, and the second via may penetrate from one surface of the laminate to the lowermost second internal electrode.

According to an exemplary embodiment, the first and second vias may have the multistage shape, the stepped shape, and a width of each stage thereof may be increased in a direction from the substrate 10 to an upper portion of the laminate.

By manufacturing the width of each stage of the first and second vias so as to be increased in a direction from the substrate 10 to the upper portion of the laminate as described above, the first via may be connected to all of the first internal electrodes, and the second via may be connected to all of the second internal electrodes.

Referring to FIG. 4B, after the forming of the plurality of vias having the multistage shape in the laminate, an upper portion of the substrate 10 and the entirety of the laminate may be applied with an insulating material 50.

Referring to FIG. 4C, the insulating layer 50 may be formed in the plurality of vias 41 and 42 by etching the insulating material 50.

The insulating layer 50 may be formed on etched cutting surfaces of the dielectric layer 11 and the first and second internal electrodes 21 and 22 in the plurality of vias 41 and 42.

Since the width of each stage of the first and second vias 41 and 42 is increased in a direction from the substrate 10 to the upper portion of the laminate, the first internal electrode 21 exposed in the first via 41 and the second internal electrode 22 exposed in the second via 42 may have the insulating layer 50 disposed on the etched cutting surfaces thereof, and top surfaces thereof may be exposed.

In addition, since the first via 41 repeats the etching multiple times to the layer to which the first internal electrode 21 is exposed and has the multistage shape, the stepped shape, and the width of each stage thereof is increased in a direction from the substrate 10 to the upper portion of the laminate, the insulating layer 50 may be disposed on the etched cutting surface of the dielectric layer 11 and the first and second internal electrodes 21 and 22, and only the top surface of the first internal electrode 21 may be exposed, after an insulating operation.

Thereby, all of the first internal electrodes 21 may be electrically connected to each other in the first via 41, and may be electrically connected to the first external electrode 131 through the first via 41.

Since the second via 42 repeats the etching multiple times to the layer to which the second internal electrode 22 is exposed and has the multistage shape, the stepped shape, and the width of each stage thereof is increased in a direction from the substrate 10 to the upper portion of the laminate, the insulating layer 50 may be disposed on the etched cut surface of the dielectric layer 11 and the first and second internal electrodes 21 and 22, and only the top surface of the second internal electrode 22 may be exposed, after an insulating process.

Thereby, all of the second internal electrodes 22 may be electrically connected to each other in the second via 42, and may be electrically connected to the second external electrode 132 through the second via 42.

According to an exemplary embodiment, the first via 41 may be connected to all of the first internal electrodes 21 disposed in the laminate, and the second via 42 may be connected to all of the second internal electrodes 22 disposed in the laminate.

According to an exemplary embodiment, since the plurality of first vias 41 are connected to all of the first internal electrodes 21 and the plurality of second vias 42 are connected to all of the second internal electrodes 22, there is no problem in forming capacitance even in a case in which one or a plurality of internal electrodes are not connected to the vias due to an operational variance.

That is, since the plurality of first vias 41 are connected to all of the first internal electrodes 21 and the plurality of second vias 42 are connected to all of the second internal electrodes 22, there is no problem in forming the capacitance of the capacitor even in a case in which some of the internal electrodes are not connected to the vias. As a result, reliability may be excellent.

The first via 41 may be plural, and a plurality of first vias 41 may have the same depth as each other. The second via 42 may also be provided in plural and a plurality of second vias 42 may also have the same depth as each other.

That is, the first via 41 may penetrate from one surface of the body 110 to the lowermost first internal electrode 21, the second via 42 may penetrate from one surface of the body 110 to the lowermost second internal electrode 22, the plurality of first vias may have the same depth as each other, and the plurality of second vias may also have the same depth as each other.

Referring to FIG. 4D, the first and second vias 41 and 42 may be filled with a conductive metal.

An operation of filling the first and second vias 41 and 42 with the conductive metal may be performed to connect the internal electrodes and the external electrodes by forming a seed layer on a surface of each of the exposed internal electrodes and then filling the conductive metal by a plating operation.

As set forth above, according to the exemplary embodiments in the present disclosure, since the dielectric and the electrodes may be collectively stacked and may be then electrically connected to each other by the via having the multistage shape, damage caused by an external environment at the time of depositing the thin-film may be significantly reduced, and a miniature product having a thinner thickness may be implemented.

In addition, since all of the respective layers requiring an electrical connection may be connected through one via, a decrease in an area caused by the via may be significantly reduced, whereby the capacitance may be increased.

In addition, since a product structure may be simplified by patterning the insulating layer within the via, the number of stacked thin-film capacitors may be increased, whereby high capacitance may be implemented.

In addition, the thin-film capacitor according to an exemplary embodiment may have low equivalent series inductance (ESL) and low equivalent series resistance (ESR).

In addition, an amount of dry etching is adjusted so that a portion at which the via and the electrode layer are in contact with each other is formed at an intermediate portion of the electrode layer in relation to the thickness of the electrode layer in order to form the via connecting the plurality of electrode layers, whereby the stable electrical connection may be obtained even in the case in which the plurality of electrodes are connected through one via.

While exemplary embodiments have been shown and described above, it will be apparent to those skilled in the art that modifications and variations could be made without departing from the scope of the present invention as defined by the appended claims.

What is claimed is:

1. A thin-film capacitor comprising:
a body in which a plurality of dielectric layers and first and second internal electrodes are alternately disposed on a substrate; and
first and second external electrodes disposed on an external surface of the body,
wherein a plurality of vias are disposed in the body,
a first via of the plurality of vias connects the first internal electrodes to each other, and penetrates from the external surface of the body to a lowermost first internal electrode,
a second via of the plurality of vias connects the second internal electrodes to each other, and penetrates from the external surface of the body to a lowermost second internal electrode, and
the plurality of vias have a multistage shape, and at least one internal electrode has an etched portion of 0.3 to 0.7 layer in relation to one layer of the internal electrode.

2. The thin-film capacitor of claim 1, wherein the first via is connected to all of the first internal electrodes disposed in the body.

3. The thin-film capacitor of claim 1, wherein the second via is connected to all of the second internal electrodes disposed in the body.

4. The thin-film capacitor of claim 1, wherein the first via is provided in plural, and
a plurality of first vias have the same depth as each other.

5. The thin-film capacitor of claim 1, wherein the second via is provided in plural, and
a plurality of second vias have the same depth as each other.

6. The thin-film capacitor of claim 1, wherein an insulating layer is disposed on the second internal electrode exposed in the first via and the first internal electrode exposed in the second via.

7. The thin-film capacitor of claim 1, wherein top surfaces of the first internal electrode exposed in the first via and the second internal electrode exposed in the second via are exposed.

8. The thin-film capacitor of claim 1, wherein a width of each stage of the plurality of vias is increased in a direction from the substrate to an upper portion of the body.

9. A method of manufacturing a thin-film capacitor, the method comprising steps of:
preparing a laminate by stacking dielectric layers and first and second internal electrodes on a substrate so that the dielectric layers and the first and second internal electrodes are alternately disposed;
forming a via by applying a photoresist to a top surface of the laminate, patterning the photoresist, and then performing an etching to expose one of the first and second internal electrodes; and
forming a plurality of vias by removing the patterned photoresist, stacking an insulating layer on the top surface of the laminate, applying the photoresist, patterning the photoresist, and then etching the insulating layer, and then filling the via with a conductive metal in a via filling operation, wherein each of the vias is formed to have a smaller width than an upper via, adjacent thereto,
wherein the plurality of vias have a multistage shape, and at least one internal electrode has an etched portion of 0.3 to 0.7 layer in relation to one layer of the internal electrode.

10. The method of claim 9, further comprising, after the step of forming the plurality of vias having the multistage shape in the laminate,
applying an insulating material to an upper portion of the substrate and the entirety of the laminate;
forming the insulating layer in the plurality of vias by etching the insulating material; and
filling the plurality of vias with the conductive metal.

11. The method of claim 10, wherein the insulating layer is formed on etched cutting surfaces of the dielectric layers and the first and second internal electrodes in the plurality of vias.

12. The method of claim 9, wherein first and second external electrodes are formed on an external surface of the laminate,
a first via of the plurality of vias connects first internal electrodes to each other, and penetrates from the first surface of the laminate to a lowermost first internal electrode, and
a second via of the plurality of vias connects second internal electrodes to each other, and penetrates from the first surface of the laminate to a lowermost second internal electrode.

13. The method of claim 12, wherein the first internal electrode exposed in the first via and the second internal electrode exposed in the second via have the insulating layer disposed on etched cutting surfaces thereof, and
top surfaces thereof are exposed.

14. The method of claim 12, wherein the first via is connected to all of the first internal electrodes disposed in the laminate, and
the second via is connected to all of the second internal electrodes disposed in the laminate.

15. The method of claim 12, wherein the first via is provided in plural, and a plurality of first vias have the same depth as each other, and
the second via is provided in plural, and a plurality of second vias have the same depth as each other.

16. The method of claim 9, wherein a width of each stage of the plurality of vias is increased in a direction from the substrate to an upper portion of the laminate.
